(19) United States
(12) Patent Application Publication
(10) Pub. No.: US 2014/0025560 A1
(43) Pub. Date: Jan. 23, 2014

(54) METHOD AND SYSTEM FOR THE EXCHANGE OF INTELLECTUAL PROPERTY ASSETS & THE FORTIFICATION OF COMPANIES WITH INTELLECTUAL PROPERTY TO ENSURE FAVORABLE OUTCOMES

(71) Applicants: Benjamin J. Kwitek, Canon City, CO (US); Harold S. Springer, Toronto (CA)

(72) Inventors: Benjamin J. Kwitek, Canon City, CO (US); Harold S. Springer, Toronto (CA)

(21) Appl. No.: 14/035,544

(22) Filed: Sep. 24, 2013

Related U.S. Application Data
(63) Continuation-in-part of application No. 12/318,553, filed on Dec. 31, 2008.
(60) Provisional application No. 61/006,212, filed on Dec. 31, 2007.

(51) Int. Cl. G06Q 50/18; G06Q 40/04

(52) U.S. Cl. CPC G06Q 50/184; G06Q 40/04
USPC 705/37

(57) ABSTRACT

A computer based method and system for exchange of intellectual property assets which permits intellectual property (IP) buyers and IP sellers to interact via a marketplace exchange includes a marketplace exchange accessed via a global communication network by IP buyers and IP sellers through utilization of computers. The marketplace exchange also includes a mechanism for posting of a listing of IP sellers on the marketplace exchange and a transactions section for facilitating transactions relating to intellectual property assets posted on the marketplace exchange.

### CROSS-REFERENCE TO RELATED APPLICATIONS

This application is a continuation in part of U.S. patent application Ser. No. 12/318,553, filed Dec. 31, 2008, entitled “METHOD AND SYSTEM FOR THE EXCHANGE OF INTELLECTUAL PROPERTY ASSETS,” which is currently pending, which claims the benefit of U.S. Provisional Patent Application Ser. No. 61/006,212, filed Dec. 31, 2007, entitled “METHOD AND SYSTEM FOR THE EXCHANGE OF INTELLECTUAL PROPERTY ASSETS”.

### BACKGROUND OF THE INVENTION

1. Field of the Invention

The invention relates to the marketing, research, and sale of intellectual property assets. More specifically, the invention relates to the creation of an online or Internet-based marketplace exchange for the listing, communication, review and sale of patents, trademarks, copyrights and other intellectual property (“IP”) assets.

2. Description of the Related Art

The modern economy has produced unprecedented economic growth and development across the world. In developed nations, including the U.S., Canada, Western Europe and Japan, this surge has been rooted in intellectual property. One cannot imagine life without computers, pharmaceutical drugs or popular consumer brands, and all of these products are protected in some way by intellectual property rights in the form of patents, trademarks and copyrights.

Almost any modern product or service is protected by various intellectual property assets. With as much of the world's manufacturing and services moving to lower cost nations, intellectual property is an important asset of many contemporary companies in ensuring their proprietary interest in these products. Without their trademarks across the planet, Coca-Cola would simply be a company that makes carbonated sugar water. IBM would not have a leadership role, and certainly would not earn a billion dollars a year on licensing, without its intellectual property portfolio.

The Internet and advanced technology allows people to witness the best products from other nations throughout the world. Today's online marketplace includes products of all sorts. Intellectual property assets have, however, not been a part of this market evolution.

Across the globe there are many specific problems to the development of intellectual property assets. The U.S. system for protecting and growing intellectual property assets is unique. The Founding Fathers implemented a system that benefited and protected the individual and his or her ideas. Since the late 18^{th} century, the U.S. Patent and Trademark Office has issued over eight million patents and millions of trademarks. When combined with the millions of copyrights, one can clearly see the enormity of intellectual property assets held within the U.S. The key problem with intellectual property is the marketplace. Like any complicated marketplace, there are literally millions of potential buyers and sellers.

There are three key components to the intellectual property marketplace that make it problematic. One, there is the inventor. Many of the intellectual property assets in the U.S. and beyond are held by individuals, colleges and small companies. Most inventors are part-time innovators and have other jobs and responsibilities that preempt the development of their intellectual property. Often times the inventor does not want to create a company to further pursue his or her ideas. They might want to sell or license their idea to another person or company. This is part of the American Dream. Unfortunately, most inventors do not have the resources (primarily money) to develop their ideas beyond the patent application, or granting of the patent. These patents are then simply forgotten, usurped, stolen or mothballed. Ultimately, when faced with developing his or her idea, including design, manufacturing, marketing and distribution, most small inventors are ill equipped for the challenge.

The stories of individual inventors presenting their ideas to large companies are almost archetypal in the American folklore. Often times these companies turn away the inventor early in the process without even seriously considering the potential for the intellectual property assets presented for their review.

There is also the problem of theft. Unfortunately, people within large and small companies sometimes listen to the ideas of the small inventor and then turn them away telling them the company is not interested. Months or years later, this same company might introduce the same product or innovation. The inventor loses the idea and the profit he or she expected. The original interest is then left with the expensive and timely dilemma of litigation.

Two, there is the company or potential buyer. A majority of large companies are not interested in dealing with countless inventors and “crazy” entrepreneurs with ideas. Even though these ideas might improve their products or launch new businesses, large companies simply do not have the human resources or procedural processes to manage this inflow of ideas.

Perhaps just as critical as large companies are small companies with products or services in new or emerging markets. Many of these companies are backed by investors—often venture capital (VC) firms. Although these small companies typically develop their own intellectual property, they forget or cannot access existing intellectual property held by other inventors or companies, and are at risk of patent infringement suits about which they may be unaware but which threaten their existence and their innovation.

The challenge, however, is that all modern companies need innovation to grow their businesses and compete in a global market. As such, there is a real imperative for innovation and new technology. Although companies typically spend a lot of money on internal research and development (R&D), they cannot hope to develop every idea first from within their cloistered walls. The market is simply too quick and diverse. As a result, how can both small and large companies access the best ideas in an efficient and corporate-friendly manner?

Three, there is the efficiency problem which supersedes both the issues of the seller and buyer. Imagine the difficulty involved with a potential exchange. The responsibility generally rests with the seller. He or she must identify target buyers for their idea. After finding them, the seller needs to contact them. If he or she is fortunate enough to find the right person or persons, they must then execute a confidentiality agreement. The inventor is then faced with presenting the idea to the company and hoping it gets reviewed by a company employee capable of appreciating the benefits offered by the idea. Alternatively, the inventor may choose to meet with the buyer's agents in person. If there is any interest, the negotiations may take months or years. This is highly impractical for all parties. This entire introduction process is lengthy and expensive.

With the foregoing in mind, it is appreciated that the exchange of intellectual property is difficult, expensive and not very effective. Unfortunately, intellectual property assets need to be in the right place at the right time to optimize their effectiveness. Most patents are owned by individuals who are not utilizing them well or owned by large companies that are not exploiting their value. The process of transferring intellectual property assets is too cumbersome and often resembles an awkward social courtship.

As a result, a need exists for a system and methodology enhancing the transfer of intellectual property assets within the marketplace. Additionally this marketplace should provide for the fortification of companies with IP assets, producing favorable outcomes. The present invention provides such a system.

### SUMMARY OF THE INVENTION

The present invention provides a marketplace where IP assets can be listed, discovered, analyzed and matched with potential users. Such IP assets are valued based on the context in which they will be utilized with an emphasis on enhancing the value of small and midsized companies with IP fortification.

The present invention also provides a method and system for more robust start-up companies poised to grow to the next business stage with a view towards strategic acquisition fortified by IP rather than being vulnerable to it. This method and system recognizes that technology continues to represent the promise of future innovation, which in turn requires protection through patented innovation.

It is, therefore, an object of the present invention to provide a computer based system for exchange of intellectual property assets which permits intellectual property (IP) buyers and IP sellers to interact. The system includes a marketplace exchange facilitating the exchange of intellectual property assets, the marketplace exchange being accessed by IP buyers and IP sellers. The marketplace exchange includes a means for finding and selecting intellectual property assets through data analysis including identifying relationships between IP buyers and IP sellers, a screening analysis section evaluating and rating intellectual property assets, a feedback and data sharing section storing surveys relating to potential interest in the intellectual property assets and including means for finding and selecting intellectual property assets through data analysis, and a transactions section facilitating purchase transactions relating to intellectual property assets posted on the marketplace exchange.

It is also an object of the present invention to provide a system wherein the means for screening and analyzing includes means for providing ratings.

It is another object of the present invention to provide a system wherein the means for screening and analyzing analyzes key words and data from third-party sources.

It is a further object of the present invention to provide a system wherein the transactions section includes the provision of a purchase option.

It is also an object of the present invention to provide a system including means for providing automated updates of intellectual property assets and information.

It is another object of the present invention to provide a system including means for providing automated updates and communications to IP buyers and IP sellers.

It is also an object of the present invention to provide a method for exchange of intellectual property assets which permits intellectual property JP) buyers and IP sellers to interact. The method includes providing a marketplace exchange facilitating the exchange of intellectual property assets. The marketplace exchange is accessed via a global communication network by the IP buyers and the IP sellers through utilization of computers. The marketplace exchange is composed of a computer-based database. The method also includes posting a listing of intellectual property assets of the IP sellers on the computer-based database, screening and analyzing intellectual property assets presented on the marketplace exchange for the evaluation and rating of intellectual property assets, and finding and selecting intellectual property assets through data analysis. The step of finding and selecting intellectual property assets through data analysis includes adjusting searches and selections based on screening and analyzing intellectual property assets and other market data as well as identifying relationships between IP buyers and IP sellers. The method also includes facilitating purchase transactions relating to the intellectual property assets.

Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is a schematic of the present system for the exchange of intellectual property assets.

FIGS. 2 and 3 are schematics showing the implementation of the marketplace exchange in the fortification of Venture Capital backed companies.

FIG. 4 is a schematic showing the interactional between portfolio companies and potential inquiries. In particular, the schematic shows the manner in which the patents connect the fortified portfolio company to the acquiring corporation using the present system. It is appreciated the geographic proximity of the encircled patents allows the acquiring corporations to expand into adjoining areas of technology through the purchase.

### DESCRIPTION OF THE PREFERRED EMBODIMENTS

The detailed embodiments of the present invention are disclosed herein. It should be understood, however, that the disclosed embodiments are merely exemplary of the invention, which may be embodied in various forms. Therefore, the details disclosed herein are not to be interpreted as limiting, but merely as a basis for teaching one skilled in the art how to make and/or use the invention.

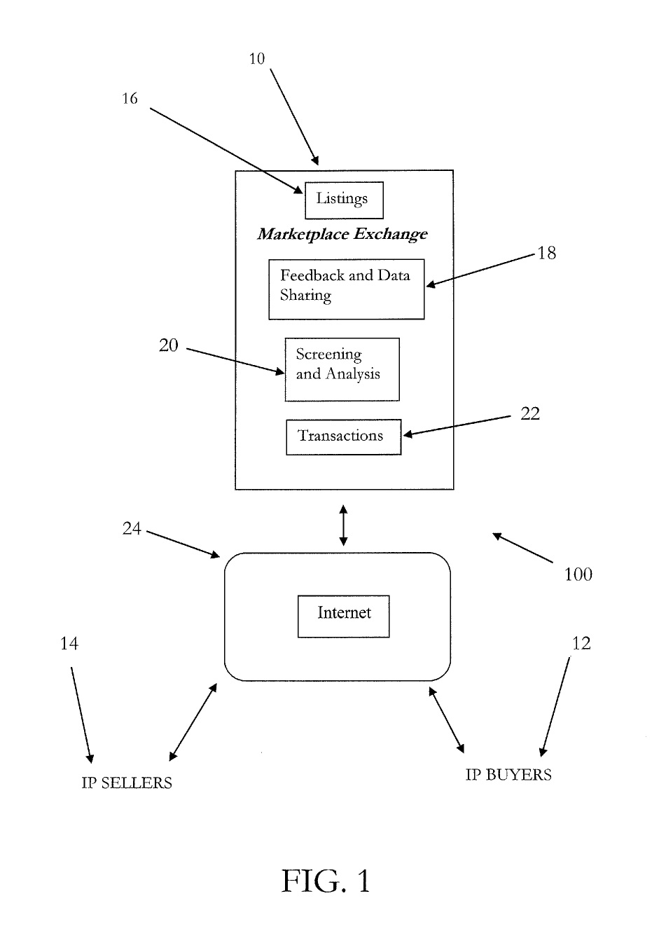

In accordance with the present invention, and with reference to FIG. 1, there are three major components to the present online, or Internet-based, computer based method and system 100 for the exchange of intellectual property assets which permits intellectual property (IP) buyers 12 and IP sellers 14 to interact via a marketplace exchange 10. In accordance with a preferred embodiment, the marketplace exchange 10 takes the form of a computer-based database of raw and processed information accessed via a global communication network (for example, the Internet) 24 by the IP buyers 12 and IP sellers 14 through the utilization of computers. As those skilled in the art will certainly appreciate, the term “intellectual property assets” or “IP assets” as used throughout the present disclosure is intended to refer to patents, trademarks, copyrights, trade secrets, trade dress, other intellectual property rights recognized by governmental agencies, and applications thereof.

First, the present invention provides for the creation of a virtual or Internet and computer based marketplace exchange 10. Second, the present invention provides a mechanism for posting of a listing(s) 16 of the intellectual property asset(s) of inventors and owners (that is IP sellers 14) on the marketplace exchange 10. Third, the present invention provides a process for IP buyer 12 registration, review through a feedback and data sharing section 18, a screening and analysis section 20, and a transactions section 22 for the purchase of (or other transactions relating to) intellectual property assets posted on the marketplace exchange 10.

With this in mind, the present method for the exchange of intellectual property assets which permits IP buyers and IP sellers to interact via a marketplace exchange includes providing a marketplace exchange 10 in the form of a computer-based database of raw and processed information accessed via a global communication network 24 by the IP buyers and IP sellers through the utilization of computers, posting of a listing(s) of the intellectual property asset(s) of IP sellers on the marketplace exchange and facilitating transactions relating to the intellectual property assets.

More particularly, and with reference to the marketplace exchange 10, the marketplace exchange 10 is a computer-based database functioning as a centralized collection point for those wishing to buy, sell and research intellectual property assets. The marketplace exchange 10 lists, manages and sells various intellectual property assets for individuals, organizations and companies around the world.

These intellectual property assets are sold, licensed or otherwise transferred via the marketplace exchange 10, which, in accordance with a preferred embodiment of the present invention, is accessed in a manner similar to a traditional web site. It is contemplated the web site would utilize one or more popular domain addresses. The web site preferably has several pages, including pages for the IP buyers 12 and IP sellers 14 of the intellectual property assets. These pages link to the information available on the marketplace exchange 10 which contains the information relevant to the IP buyer 12 or IP seller 14. The operators or managers of the present system 100 would earn money on the listing and sale of the intellectual property assets via the marketplace exchange 10. It is further contemplated subscription services could be offered to potential IP buyers 12. These services would provide various benefits to the subscribers.

As briefly mentioned above, the present invention provides for posting of a listing(s) 16 of the intellectual property asset(s) of inventors and owners (that is, IP sellers) on the virtual online marketplace exchange 10. Individual inventors, organizations and various companies preferably post their intellectual property assets that they wish to sell on the online marketplace exchange 10 via computer exchange with the computer-based database of the marketplace exchange 10. The owner (that is, the IP seller 14), or other person responsible for handling transactions relating to the intellectual property asset, is responsible for posting the number(s) (that is, the identifying registration, patent, application or other information identifying the intellectual property asset to be sold) and some summary information on the site (that is, the database of marketplace exchange 10) for listing and review in accordance with the present invention. After entering the information on the input screens, the data is transmitted to the managing company for the online marketplace exchange 10 of the present invention. This data is then incorporated into the online database of the marketplace exchange 10 so that other users may see and use the information.

In accordance with a preferred embodiment of the present invention, the company managing the online marketplace exchange 10 screens and analyzes the intellectual property assets that are presented on the marketplace exchange 10 via a screening and analysis section 20. Moreover, the intellectual property assets are evaluated and grouped so as to be more useful to potential IP buyers 12. The evaluation and ratings are based on objective and, perhaps, subjective measures. Evaluations, that is, implementation of the screening and analysis section 20, preferably occur through the use of software programs developed to analyze key words and data from third-party sources. The use of experts, including those within the various fields (such as a professor of computer science) might also be employed to help grade the submitted intellectual property assets.

Each piece of intellectual property listed on the online marketplace exchange 10 offers a purchase option via the transactions section 22 of the marketplace exchange 10. This could be a set price or it might involve an auction system. This will depend on the preferences of the IP seller 14 and IP buyer 12.

The present invention also discloses a process for IP buyer 12 registration, review and purchase of intellectual property assets posted on the online marketplace exchange 10. As one might imagine, companies are generally interested in finding new ideas that assist their businesses. This is particularly true for startups or VC-backed companies. The present invention and online marketplace exchange 10 facilitates this process.

Before purchasing intellectual property assets, the prospective IP buyers 12 are surveyed regarding their business and potential interests for utilization in the feedback and data sharing section 18 of the marketplace exchange 10. This information is stored within a profile at the site (that is, the marketplace exchange 10). This profile preferably has two components. The full profile is stored in a proprietary database that only the managers of the marketplace exchange 10 may access, as this full profile would likely contain confidential information. Thus, the full profile is edited and summarized for incorporation into the marketplace exchange 10 profile online. The full and confidential profile is then compared to the existing IP seller 14 information and intellectual property assets. This preferably happens through automated search and organization programs developed for this process. In accordance with a preferred embodiment, it is contemplated these programs would use mathematical equations (such as algorithms) to link various pieces of data to one another. This process could also be adaptive in that new inputs or new data might alter the comparison process. Moreover, the results themselves might then become part of the record and, along with user input, become referenced in future searches. In this way, the present process would develop a virtual intelligence in its organization and matching capabilities. It may also utilize match-making done by project or field managers at the online exchange company. As a result, IP buyers 12 could be offered the chance to view relevant intellectual property assets upon their registration. This matching also benefits the VC-backed company in its quest to be acquired since its IP assets and patent purchases could be tailored to the needs of the potential acquirer.

The present system 100 also allows for automated updates with relevant intellectual property assets and even informational updates. This may include articles, statistics and general market trends. All of this data related to the intellectual property assets is summarized and presented to the users in various forms. These might include priority lists, charts, tables and graphical representations of the data. Common programs such as Adobe Acrobat, Microsoft Excel and Microsoft PowerPoint could be used to present, manage and save the data. These preferably include pictorial views of the intellectual property landscape—a visual way to show missing pieces within an intellectual property portfolio for example. The software programs and coding manage the database of the marketplace exchange 10 and provide options as to how the users might want to be updated. Users are preferably given a profile and password to access updates within their section or profile. The updates, or even the availability of an update online, could also be sent via email or text messaging to the users. The users are surveyed as to their preferences for the type, quantity and methods that they would prefer for their updates.

The present system 100 also provides virtual intelligence through the use of advanced environmental scanning and pattern recognition within the intellectual property space and beyond. It is anticipated the highlighted technologies and intellectual property assets could be connected to general trends and societal progress. This environmental scanning and pattern recognition might employ electronic searches empowered by software programs designed to find relationships.

Some of this computational power has been demonstrated by IBM and its Watson supercomputer. What was effectively illustrated on a television quiz show was the power to search massive amount of data to obtain “reasonable” answers. This computing power could be engaged to find and link IP assets between donor and host (portfolio) companies. This type of matching clearly benefits everyone as it takes full advantage of the enormous data storage that exists in the modern economy.

In summary, the present invention provides a solution to the current problem of underdeveloped or underutilized intellectual property assets throughout the world. The present invention allows a natural and dynamic marketplace to develop. The owners of unused or underutilized intellectual property assets will become IP sellers in this online system. The individuals and companies in the market will become IP buyers of intellectual property assets in this online system. When combined with advanced search, listing and intelligence features, this system and invention provides undeniable benefits to our modern economy.

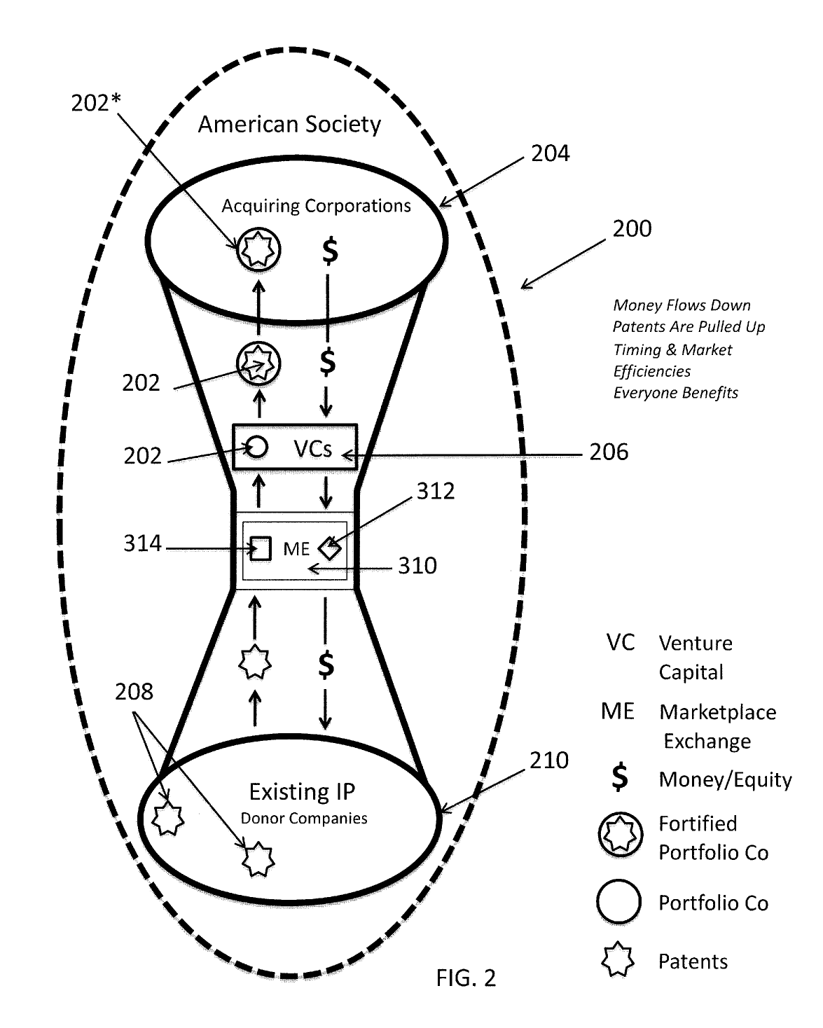

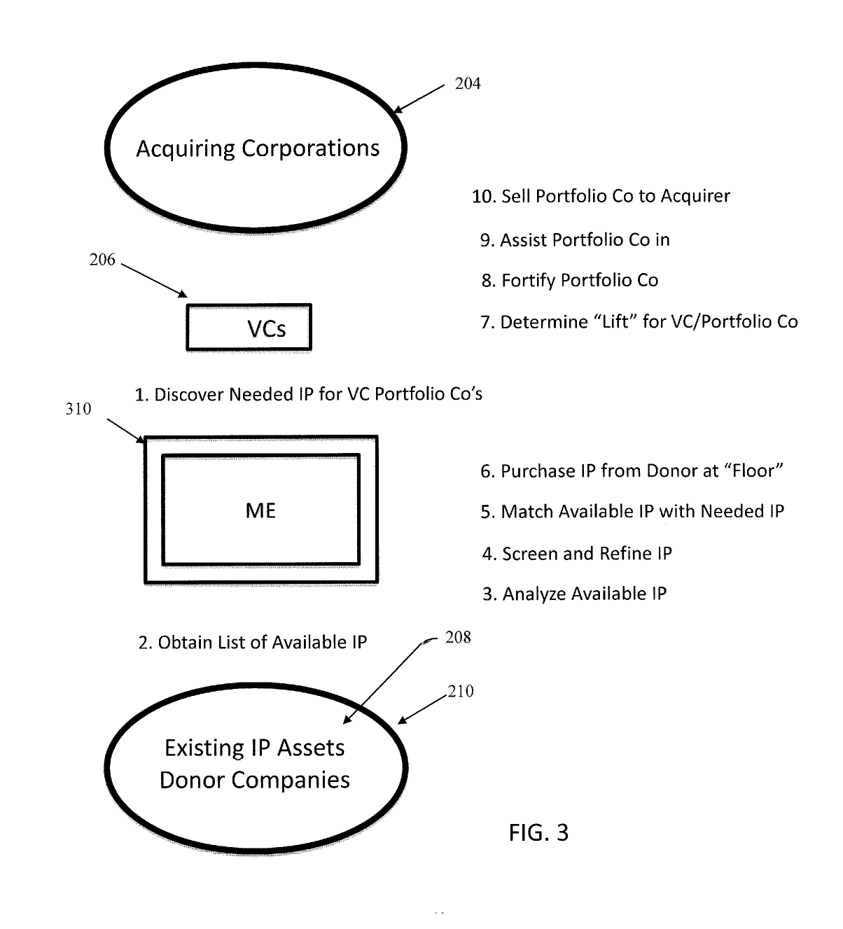

The concepts underlying the system as described above may be enhanced and applied to problems specifically confronting small, venture capital (“VC”) backed companies, which require IP assets to succeed. It is well appreciated that small companies (including VC-backed entities) need IP assets to operate effectively and gain market share. The embodiment described below and pictured in FIG. 2 provides a system 200 and method for moving IP assets from those owning the assets to those needing the assets in a manner that achieves the goal of fortifying these small companies 202 on terms that benefit both the VC 206 and the donor companies 210. When executed properly, the system 200 allows them to succeed and continue on their road to innovation and growth. In this way the present system provides a mechanism so that VC-backed companies 202 may quickly find out what patents they need and whom to pay, rather than putting out their product and waiting to be sued. The present system 200 also gives VC-backed companies 202 a way to expand their businesses so that they can grow in the direction of a potential acquiring corporation 204 and its IP. Note that in this disclosure, “VC-backed companies” and “portfolio companies” may be used interchangeably.

The present system 200 addresses these issues by providing a mechanism for building innovation upon innovation. By providing innovative companies, for example, VC-back companies 202, with the IP fortification 208 they need to succeed, these companies are more likely to fulfill their missions of developing and deploying technology that will help define the next generation. Without such fortification, these companies more than likely will be unable to generate the funding needed to fulfill their mission, will be hemmed in by monetary constraints and will fold before they even have a fair chance at succeeding. This downward spiral can cost investors (including VC firms 206) countless millions of dollars Aligning the potential of the VC-backed company 202 with the protection of existing IP assets (that is, the IP fortification) 208 makes for a safer and smarter investment poised for greater value and enhanced innovation.

With this in mind, the present system 200 attempts to remove the stigma associated with the Non-Practicing-Entity (NPE), as well as entities practicing but not making use of their entire patent portfolio, who desire to obtain value from their IP assets through the licensing thereof. Non-Practicing-Entities are often referred to as “trolls.” However, this “troll” label, as well as the backlash against NPEs, is fueled by large companies and politicians that do not have adequate information and succumb to popular pressure and lobbying efforts. For example, does an inventor who has her idea stolen by a large corporation deserve to be called a “troll” if she simply asks for a licensing agreement from them? Do the world's best colleges and universities deserve the “troll” moniker simply because they do not have the money to develop the fruits of their research? This negative public relations reality has caused NPEs to struggle more with the perfectly legitimate sale and/or licensing of their IP portfolios. The negative image applied to NPEs likely comes from the manner in which the transactions take place; that is, because a proper marketplace does not exist the courts actually function as the marketplace and courts are ultimately horribly inefficient and expensive. The present system 200 allows NPEs and other practicing entities with under-utilized IP, who in accordance with the present invention become donor companies 210, the chance to have their IP assets 208 entered into the marketplace 310 and ultimately used to enhance the value of VC-backed companies 202 with the associated upside potential.

In addition to the problems associated with the perception of NPEs, the valuation of IP assets is also very challenging and mainly framed by legal costs and litigation results. However, many will agree that litigation is not the ideal place to provide for the exchange of property of any kind. The present system 200 addresses this problem by providing a marketplace 310 that establishes value and price using the economics of business as opposed to the deterrent economics of the courtroom.

It is appreciated that large patent owners have extreme difficulty finding small and medium size business buyers for their IP assets as evidenced by the fact most sales or licensing deals occur between large entities. Since IP assets have a limited life, everyday these underutilized patents are losing value. This lost value affects the inventor, the owner, the potential users of the technology, and society at large. It is analogous to the strawberries rotting on the dock because no one has paid for them to allow for their timely distribution.

Since its “official beginning” in the late 1950s and early 1960s, venture capital has funded countless companies—many of which have become leading global companies such as Apple, Microsoft, Google and Facebook. It is one of the celebrated aspects of business in the United States and embodies the “American Dream.” Today there are hundreds or thousands of VCs across the U.S. and around the world. These VCs use the money of individuals, businesses and investors to start, incubate and grow small companies. These small companies form portfolios for the venture capital firm.

Many VC-backed companies are in high-technology fields where proprietary technology is well regarded and respected. The object of every VC is to make money on its investments. An “exit strategy” is what VCs call it when their portfolio company (that is, a VC-backed company) is sold. Consequently, the creation of “exit strategies” is an essential part of the VC business cycle.

Most VC-backed companies pursue some IP to add value to their investment prospectus and market assessment. The number of patents in an average start-up however is quite small due to the inefficiency of the commercial world (i.e., the time and cost of getting patents) and the need in the commercial world for a method and system for the exchange of IP assets to connect strategic buyers and sellers. Most VC-backed companies would greatly benefit from additional IP assets. When fortified with appropriate IP assets, the value of these portfolio companies increases substantially. The example of Facebook is illustrative. Prior to filing their Initial Public Offering (IPO) documents with SEC, Facebook had less than 50 patents. Within the months leading up to the IPO and beyond, that number jumped to over 1,000. Today, Facebook is a public company with a market capitalization of approximately $100 Billion. What is true for Facebook is also true for other aspiring VC-backed companies—patents add economic value. This increased value makes it more likely these VC-back companies will be acquired by other companies or ready for an IPO of their stock, thereby achieving the ultimate exit strategy of the VCs funding the portfolio company.

With the underutilized IP assets of large companies and entities and the needs of small, VC-backed companies in mind, the present method and system 200 assists in the transfer of IP assets 208 from large entities, NPEs, and other donor companies 210 to small and mid-sized companies 202—particularly those backed by VC money.

In accordance with the present invention, the donor company 210, that is, most likely the owner of a large portfolio of IP, would provide a listing of their entire IP portfolio. It should be noted that the large portfolio holder might also be a corporation, university or NPE. The ownership entity does not matter materially with respect to how these under-utilized IP assets 208 can be developed and/or monetized. In accordance with a preferred embodiment, a marketplace exchange 310 as described above with reference to FIG. 1 is utilized. As such, the donor company 310 posts its intellectual property assets 208 they wish to sell on the online marketplace exchange 310 via a computer exchange with the computer-based database 312 of the marketplace exchange 310. The donor company 210 is responsible for posting the number(s) (that is, the identifying registration, patent, application or other information identifying the intellectual property asset to be sold) and some summary information on the site (that is, the database of marketplace exchange) for listing and review in accordance with the present invention. After entering the information on the input screens, the data is transmitted to the operating or managing company for the online marketplace exchange 310 of the present invention. This data is then incorporated into the online database 312 of the marketplace exchange 310 so that other users may see and use the information. This database 312, or marketplace exchange 310, may be private and accessed only by agreement among approved users within the management company and by other stakeholders.

This listing of IP is then analyzed by computer software and humans to create priorities, ratings and secondary listings. Algorithms operating within the marketplace flesh out various predetermined criteria related to the portfolio of patents, that is, the IP assets 208. The donor company 210 may prioritize the portfolio as to how specific elements of the portfolio are to be used.

In conjunction with the development of an IP portfolio listing, the VC firms 206 are then studied with various mechanisms. These might include surveys and research into their current holdings. Although there is overlap, generally VC firms have emphasis or specialization areas. For example, a VC firm may prefer investments in green energy or biotech. These specializations can be immediately compared to the know patents 208 from the libraries of the donor companies 210. In this way, the list of potential patents is immediately narrowed. Furthermore, VC firms 206 are interviewed as to which portfolio companies 202 (that is, companies which are receiving funding from the VC firms 206) had the highest urgency for a potential exit strategy and might require fortification with IP assets 208 of the IP portfolio maintained in accordance with the present system. These VC-backed companies 202 would then be analyzed to determine their SWOTs (strengths, weaknesses, opportunities, threats) using algorithms 314 developed to flush out various predetermined criteria relating to their IP needs. In fact, the VC-backed companies 202 may prioritize their needs as to how specific elements of the portfolio would be used. The analysis of the VC-backed companies 202 will focus upon the following factors:
potential infringement problems—which may be readily solved with low cost licensing of underlying patents that are not otherwise available;
potential opportunities for new IP or the “layering” of innovation on innovation creating new IP;
potential opportunities for combining preexisting IP with newly developed IP to create a synergistic effect with enhanced value;
management issues including the need to bring the company to a more effective level of functioning with additional resources including new money and people; and/or
potential advantages of tax, corporate and capital restructuring; combining the restructuring with the IP decisions including the choice of jurisdiction and governance.
   The foregoing is designed to take the VC-backed company 202 forward so that it may operate at a higher level in a more robust marketplace.

As a part of the analysis, the present system 200 identifies and labels potential infringement issues before anyone enters a courthouse. This method is called “Infringement Flagging.” Through the use of human and computer analysis, the present system creates a matrix showing which patents from the donor company 210 may be infringed or improperly used by the portfolio company 202. It is appreciated that the review might include a rating or threat level (i.e. Red Flag Infringement, Yellow Flag Infringement). This data and threat level is useful to the VCs 206 and their portfolio companies 202, as it identifies their potential liability in the market. This data reinforces the rationale to allow for the fortification of the portfolio company 202.

This “Infringement Flagging” can also be used to show the acquiring corporation 204 where its competitors might infringe once it acquires the IP assets (that is, the patents) 208 from the portfolio company 202*. In other words, the acquirer may very well want leverage on one of its competitors and this acquisition would give them that advantage—all wrapped up in the context of growing the company by acquiring another company. The opposite side of this coin is also helpful in the overall analysis. If the potential acquirer (that is, the acquiring corporation) 204 passes on the deal, it has advance knowledge of its vulnerability with these patents should one of their competitors complete the acquisition.

It should be noted that the identification of available IP assets 208 and the needed IP assets 208 of the VC-backed company 202 can occur in the reverse order to what has just been described. In other words, the needs of the VC-backed companies 202 may precede the identification of the available IP assets 208 from the large portfolio of the donor company 210. This process will be likely be somewhat dynamic and depend on the nature of the opportunity as well as the involved participants.

Once libraries of available patents are developed, and a collection of information relating to various VC firms 206 and VC-backed companies 202 is developed, the matchmaking process begins with the host (or portfolio) companies 202. In particular, the data from the VC-backed companies 202 is matched with the IP assets 208 within the IP library to find suitable matches, links and pricing. This process incorporates the initial specializations of the VC firm 206 with that of the donor companies 210. The proper patents 208 are then offered to the VC 206 to enhance the value of their portfolio companies, and ultimately result in IP fortified VC companies 202*. As discussed, this IP fortification is based on various factors, not the least of which is the proactive prevention of potential litigation. Once enhanced or fortified, these IP fortified VC companies 202* are then selectively matched to potential acquiring corporations 204 (highlighting the value of the new IP assets 208 as it relates to them). Once sold, the VC 206, Donor Company 210 and operating/management company would enjoy the profits. In addition to the profits realized from the transaction itself, it is appreciated that the service providers, that is, the operators or managers of the present system 200, would also be rewarded with payments for facilitating the matching and deal making service provided in accordance with the present invention. In particular, matching is facilitating by comparing and contrasting the following factors using various weighting techniques:
1. Define by industry.
2. Define by technology focus area, specialization or art.
3. Crosslink patents in the technology focus area between the donor entity and the VC and its emphasis areas of investment.
4. Analyze cross-linked patents from the donor entity to the portfolio companies within the VC.
5. Define gaps in utilization of IP—for example, IP for robotics within the pharmaceutical industry finding a suitable match within alternate industries, such as, military or agriculture.
6. Identify the optimal strike price “floor price” acquisition range (price at which a purchase/license/assignment/margin/option etc., will be executed) from the donor based upon current use of the IP.
7. Identify the transfer price for the VC/portfolio company (which may be cash or equity) based upon various factors. These include: the potential use of the IP (industry in which it will be used), the size of the venture, the value enhanced of the IP to the portfolio company or target (i.e., “the lift”) which fortifies the portfolio company for further development, market share, and/or acquisition, new influx of money and/or strategic management necessary to grow the portfolio company to the next business stage and potentially make the match possible, etc.
8. Identify the acquisition price of the portfolio company reflecting the value enhancement and overall fortification that has been provided to the portfolio company as it relates to the most strategic acquirer. This bears in mind the growth, development and fortification of the acquirer based upon the purchase of the IP by the portfolio company and the subsequent purchase by the acquirer.

An advantage to this method and system is that the acquiring corporation also gets the people, facilities, structures and business practices of the portfolio company. There is a benefit to bringing in new companies, staffed by energetic people who often do things differently than those in the large acquirer. One only needs to look at Google or Yahoo to see how small company purchases have positively impacted their culture. There are also some potential tax benefits derived from the purchase of a company versus the purchase of specific IP assets by themselves.

Another advantage of this method and system relates to the large acquiring corporation 204. It is simply better investor relations to buy a small company with great IP as opposed to buying patents by themselves. It is the difference between a merger and a blue-sky deal on “The Street.” It is much more effective public relations for both companies and the VC firm 206 to engage in accretive mergers and acquisitions as opposed to hostile licensing negotiations with potential plaintiffs. Any news of potential litigation generally drives a company's stock price down whereas news of an acquisition generally accompanies an increase in stock price. So, what could be a small deal of perhaps $25 Million could cause a near exponential increase in the acquirer's market capitalization—perhaps a $1 Billion dollar increase. This type of positive leverage completely changes the calculus as it relates to IP held by other companies.

The foregoing method and system (of enabling startup companies to quickly ascertain the patents they require on acceptable commercial terms) must be contrasted with the existing economic drain and inefficiency of startup companies creating a product or service, which may contain an imbedded or pregnant suit that can threaten their existence, viability and innovation. The threat of suit also adversely impacts the VC firm and other investors who supported the startup. In addition there is a negative economic ripple effect for the community and broader economy.

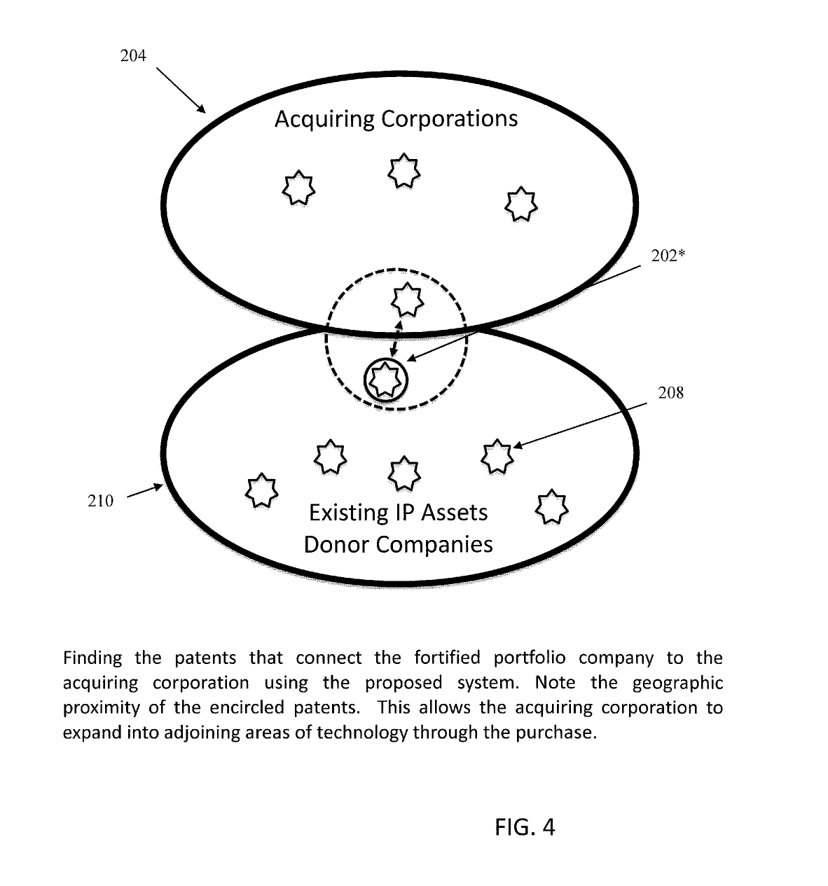

When analyzing the portfolio companies 202 vis-à-vis their potential acquirers 204, it is useful to see the connections between their businesses—with a focus on their IP assets. This process depicted in FIG. 4 would include obtaining a list of newly issues patents and newly filed patent applications from the potential acquiring corporation 204. With these lists of new patents, software and human reviews can create a summary of where the company is developing new technologies. With these patent numbers, searches can be conducted on other patents 208 that relate to this expansion. This search likely involves keywords and other search criteria. Ideally, this search and analysis reveals patents 208 from donor companies 210 that dovetail with the potential acquiring corporation 204 thereby accelerating the purchase of the fortified portfolio company 202*.

Once this data is refined, a business case can be made for why the acquisition makes sense. In essence, the patents 208 create a virtual “bread crumb trail” between the companies that encourages discussions and a potentially synergistic deal. This system is also enhanced by the use of graphical models or maps. The patents 208 in a particular field can be situated on a 3-D computer map showing how the pieces are linked and why that is important opposite what competitors are doing in the marketplace. This visual modeling also allows for a certain degree of forecasting as to what patented technologies may be next. For example, the purchase of a fingerprint recognition technology company by Apple has predicted new patent filings and an emphasis on biometrics in mobile devices. The present system 200 capitalizes on this knowledge and allows for the operating or management company to beat the market in its marketplace exchange transactions.

It is also important to consider the “layering” of innovation on innovation that results from the matching and exchange system presented here. Sometimes even the best ideas exist within a silo inside a division, company or industry. When outside ideas are matched with these internal ideas, the results can be wonderfully synergistic. It is more than a function of addition. It more closely resembles a geometric expansion as the one innovation is layered upon another innovation, which produces unexpected results. These results allow the fortified company 202* to be more successful but the positive repercussions do not end there. The donor company 210 also gains some financial reward as well as recognition of the value of their ideas outside of their direct business. The broader economy and even the entire society benefits when great ideas are developed and shared.

While the preferred embodiments have been shown and described, it will be understood that there is no intent to limit the invention by such disclosure, but rather, is intended to cover all modifications and alternate constructions falling within the spirit and scope of the invention.

1. A computer based system for exchange of intellectual property assets which permits intellectual property (IP) buyers and IP sellers to interact, comprising:
a marketplace exchange facilitating the exchange of intellectual property assets, the marketplace exchange is accessed by IP buyers and IP sellers;
the marketplace exchange includes:
means for finding and selecting intellectual property assets through data analysis including identifying relationships between IP buyers and IP sellers
a screening analysis section evaluating and rating intellectual property assets,
a feedback and data sharing section storing surveys relating to potential interest in the intellectual property assets and including means for finding and selecting intellectual property assets through data analysis, and
a transactions section facilitating purchase transactions relating to intellectual property assets posted on the marketplace exchange.

2. The system according to claim 1, wherein the means for screening and analyzing includes means for providing ratings.

3. The system according to claim 2, wherein the means for screening and analyzing analyzes key words and data from third-party sources.

4. The system according to claim 1, wherein the transactions section includes the provision of a purchase option.

5. The system according to claim 1, further including means for providing automated updates of intellectual property assets and information.

6. The system according to claim 1, wherein the system includes means for providing automated updates and communications to IP buyers and IP sellers.

7. A method for exchange of intellectual property assets which permits intellectual property (IP) buyers and IP sellers to interact, comprising:
providing a marketplace exchange facilitating the exchange of intellectual property assets, the marketplace exchange is accessed via a global communication network by the IP buyers and the IP sellers through utilization of computers, the marketplace exchange is composed of a computer-based database;
posting a listing of intellectual property assets of the IP sellers on the computer-based database;
screening and analyzing intellectual property assets presented on the marketplace exchange for the evaluation and rating of intellectual property assets;
finding and selecting intellectual property assets through data analysis, the step of finding and selecting intellectual property assets through data analysis includes adjusting searches and selections based on screening and analyzing intellectual property assets and other market data as well as identifying relationships between IP buyers and IP sellers; and
facilitating purchase transactions relating to the intellectual property assets.

8. The method according to claim 7, wherein the step of screening and analyzing includes the step of providing ratings.

9. The method according to claim 8, wherein the step of screening and analyzing includes analyzing key words and data from third-party sources.

10. The method according to claim 7, wherein the step of facilitating transactions includes providing a purchase option involving a set price or auction system.

11. The method according to claim 7, further including the step of storing information obtained from buyers in a feedback and data sharing section.

12. The method according to claim 7, further including the step of providing automated updates of intellectual property assets and information.

13. The method according to claim 7, further including the step of providing automated updates and communications to IP buyers and IP sellers.
